(19) United States
(12) Patent Application Publication
(10) Pub. No.: US 2011/0196992 A1
(43) Pub. Date: Aug. 11, 2011

(54) METHOD FOR DISMOUNTING A STORAGE DEVICE, AND COMPUTER PROGRAM PRODUCT AND ELECTRONIC APPARATUS FOR IMPLEMENTING THE METHOD

(75) Inventors: Chun-Lung Cheng, Taipei Hsien (TW); Ching-Lung Chen, Taipei Hsien (TW)

(73) Assignee: WISTRON CORPORATION, Taipei Hsien (TW)

(21) Appl. No.: 12/793,558

(22) Filed: Jun. 3, 2010

(30) Foreign Application Priority Data
Feb. 5, 2010 (TW) 099103525

(51) Int. Cl. G06F 13/10

(52) U.S. Cl. 710/15

(57) ABSTRACT

A method for dismounting a storage device includes the steps of: inspecting operation of a USB communication protocol between an electronic apparatus and a computer to determine whether a handshaking process therebetween has been completed; when it is determined that the handshaking process has been completed, terminating programs, storing data in a storage device of the electronic apparatus, and determining whether storing of the data has been completed; dismounting the storage device from the electronic apparatus and notifying the computer to mount the storage device when storing of the data has been completed; and restarting the USB communication protocol and repeating determination as to whether the handshaking process has been completed when it is determined with reference to a timer of the electronic apparatus that storing of the data has not been completed after a preset time limit has lapsed.

### CROSS-REFERENCE TO RELATED APPLICATION

This application claims priority of Taiwanese Application No. 099103525, filed on Feb. 5, 2010.

### BACKGROUND OF THE INVENTION

1. Field of the Invention

The present invention relates to a method for dismounting a storage device, more particularly to a method for dismounting a storage device implemented using computer program software instead of hardware detection.

2. Description of the Related Art

An electronic apparatus, such as a personal navigation device, usually utilizes a universal serial bus (USB) interface to serve as a data and power transmission interface. Since many commercially available electronic apparatuses are provided with a flash memory, they can serve as storage apparatuses. When the electronic apparatus is connected to a computer via the USB interface, a storage device of the electronic apparatus will be mounted to the computer, and an operating system (OS) of the electronic apparatus will implement a dismount operation correspondingly. Before the OS of the electronic apparatus can dismount the storage device of the electronic apparatus, it is required to terminate a relevant program and store data. Otherwise, data may be lost and a partition table of the storage device may even be corrupted.

Thus, to avoid mounting the storage device to the computer before the storage device has been safely dismounted, the existing technique is related to hardware detection, i.e., detection of an identification (ID) pin of the USB interface, when the electronic apparatus is connected to the computer via the USB interface. Once the ID pin generates a signal, this indicates that the electronic apparatus has been connected to the computer, and the OS notifies an upper-level application program for program termination and stores data, followed by dismounting and mounting of the storage device. However, in practice, the ID pin of the USB interface is usually used for other functions, and might be unavailable for use to detect a connection state. Therefore, it cannot be ensured that the storage device of the electronic apparatus has been dismounted safely.

Additionally, when the computer detects that a storage apparatus is connected to a USB interface thereof and is unable to identify the storage apparatus within an allowable connecting time limit, the computer will generate a message of an unidentifiable apparatus and terminate operation of a USB communication protocol to thereby result in failure to mount the storage apparatus.

### SUMMARY OF THE INVENTION

Therefore, an object of the present invention is to provide a method for dismounting a storage device that ensures safe dismounting and mounting of the storage device by inspection of operation of a universal serial bus (USB) communication protocol in association with a reset mechanism instead of conventional hardware detection.

Another object of the present invention is to provide an electronic apparatus that ensures safe dismounting and mounting of a storage device by inspection of operation of a USB communication protocol in association with a reset mechanism instead of conventional hardware detection.

A further object of the present invention is to provide a computer program product comprising a machine readable storage medium having program instructions stored therein which when executed cause an electronic apparatus having a storage device and a universal serial bus (USB) interface to perform a method for dismounting the storage device.

Accordingly, a method for dismounting a storage device is implemented using an electronic apparatus that includes the storage device and a USB interface. The method comprises the steps of:

a) inspecting operation of a USB communication protocol between the electronic apparatus and a computer, that includes a USB interface and that is connected to the electronic apparatus via the USB interfaces, to determine whether a handshaking process between the electronic apparatus and the computer has been completed, and proceeding to step b) when it is determined that the handshaking process has been completed;

b) storing data in the storage device, determining whether storing of the data in the storage device has been completed, proceeding to step c) when it is determined that storing of the data in the storage device has been completed, and proceeding to step d) when it is determined that storing of the data in the storage device has not been completed after a preset time limit has lapsed, the preset time limit being shorter than an allowable connecting time limit defined by the computer;

c) dismounting the storage device from the electronic apparatus, and notifying the computer to mount the storage device; and

d) restarting the USB communication protocol between the electronic apparatus and the computer, and repeating step a).

Preferably, the method for dismounting a storage device further comprises, before step a), the steps of:

i) performing detection to determine whether the USB interface of the electronic apparatus is connected to the USB interface of the computer; and

ii) when it is determined that the USB interface of the electronic apparatus is connected to the USB interface of the computer, starting the USB communication protocol between the electronic apparatus and the computer, and starting countdown to the preset time limit.

According to another aspect, an electronic apparatus comprises a central processing unit, a storage device, a timer and a USB interface. The timer is configured to countdown a preset time limit. The storage device stores an operating system including a USB driver that is to be executed by the central processing unit. The USB interface is adapted to be connected to a USB interface of a computer to thereby trigger the central processing unit to execute the USB driver. The central processing unit is operable to execute the USB driver and to perform the steps of:

inspecting operation of a USE communication protocol between the electronic apparatus and the computer to determine whether a handshaking process between the electronic apparatus and the computer has been completed; and

when it is determined that the handshaking process has been completed, storing data in the storage device, determining whether storing of the data in the storage device has been completed, dismounting the storage device from the electronic apparatus and notifying the computer to mount the storage device when it is determined that storing of the data in the storage device has been completed, and restarting the USB communication protocol between the electronic apparatus and the computer and repeating determination as to whether the handshaking process between the electronic apparatus and the computer has been completed when it is determined with reference to the timer that storing of the data in the storage device has not been completed after the preset time limit has lapsed.

Preferably, the central processing unit is configured to transmit a reset signal to the computer for restarting the USB communication protocol between the electronic apparatus and the computer and for causing the computer to restart countdown to an allowable connecting time limit when it is determined with reference to the timer that storing of the data in the storage device has not been completed after the preset time limit has lapsed.

Preferably, while executing the USB driver, the central processing unit determines that the handshaking process has been completed when at least one particular piece of information transmitted between the electronic apparatus and the computer has been confirmed. The particular piece of information includes one of an address, a transmission rate, and a transmission volume.

Preferably, the storage device further stores an application program. While executing the USB driver, the central processing unit is configured to notify the application program for program termination when the central processing unit determines that the handshaking process between the electronic apparatus and the computer has been completed.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram illustrating a preferred embodiment of an electronic apparatus for implementing a method for dismounting a storage device according to this invention; and

FIG. 2 is a flow chart illustrating a preferred embodiment of a method for dismounting a storage device according to this invention.

### DETAILED DESCRIPTION OF THE PREFERRED EMBODIMENT

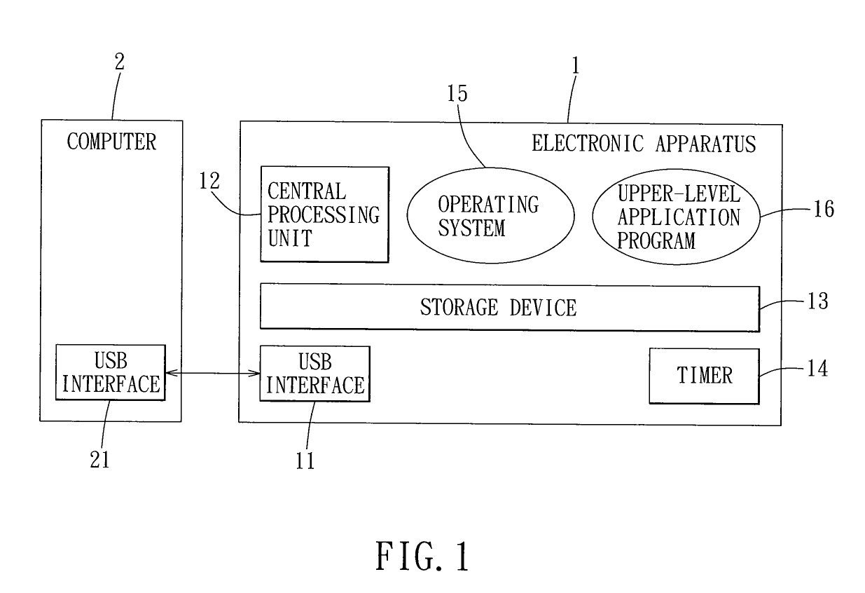

Referring to FIG. 1, the preferred embodiment of a method for dismounting a storage device is implemented using an electronic apparatus 1. The electronic apparatus 1, such as a personal navigation device, a smart phone, a personal digital assistant, etc., is adapted to transmit data through a connection between a universal serial bus (USB) interface 11 thereof and a USB interface 21 of a computer 2.

The electronic apparatus 1 further includes a central processing unit (CPU) 12, a storage device 13 (such as a flash memory), and a timer 14. The storage device 13 stores an operating system 15, at least one upper-level application program 16, and data. The operating system 15 includes a USB driver. The USB driver can be pre-stored in a machine readable storage medium of a computer program product, such as a magnetic disk or an optical disk provided by a manufacturer of the electronic apparatus 1, or a storage device of an internet server, and is provided for downloading to and installing in the electronic apparatus 1.

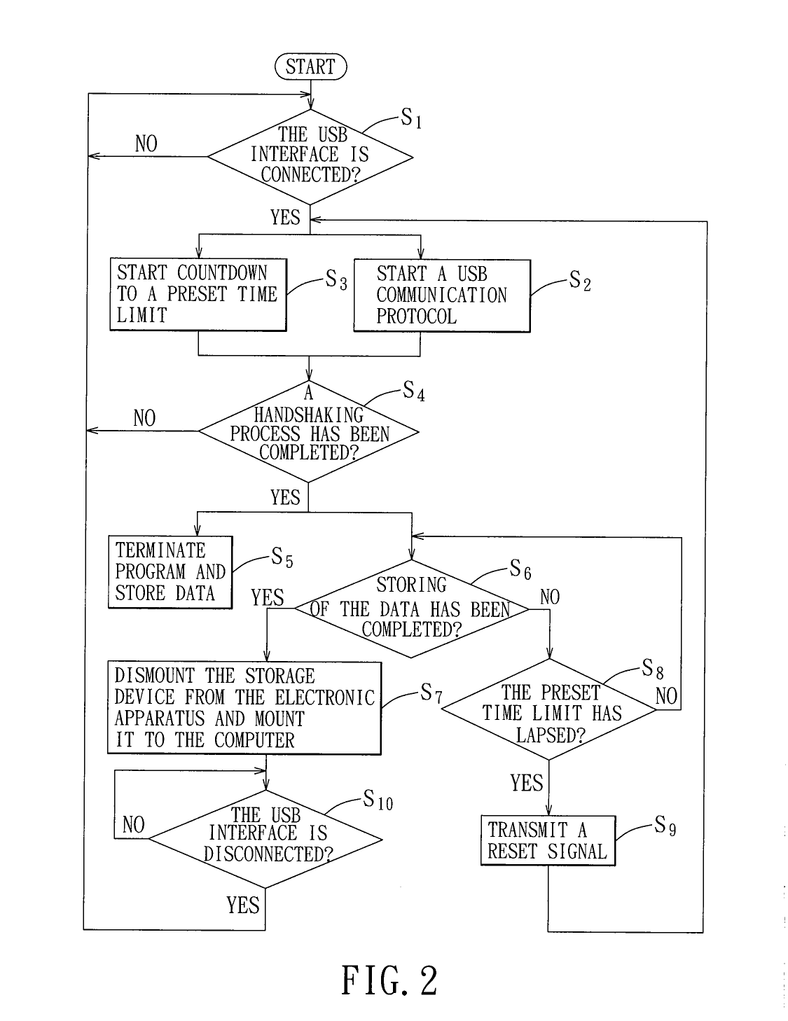

The preferred embodiment of a method for dismounting a storage device implemented using the electronic apparatus 1 will now be described in the succeeding paragraphs with reference to FIGS. 1 and 2.

Step S₁ is to determine whether the USB interface 11 of the electronic apparatus 1 is connected to the USB interface 21 of the computer 2. In this embodiment, while executing the operating system 15, the CPU 12 makes the determination associated with signals from four pins of the USB interface 11. When the connection between the USB interface 11 of the electronic apparatus 1 and the USB interface 21 of the computer 2 is completed, the signals generated by the pins of the USB interface 11 of the electronic apparatus 1 trigger the CPU 12 to execute the USB driver, and the central processing unit 12 determines that the USB interface 11 is connected, and proceeds to execute steps S₂ and S₃.

Step S₂ is to start a USB communication protocol between the electronic apparatus 1 and the computer 2. Generally, the USB communication protocol includes, but is not limited to, a setup stage, a data stage and a status stage. In the setup stage, the computer 2 is configured to query the electronic apparatus 1 about the type of descriptors and an apparatus model according to a preset address zero and a preset end point number zero. In response to the query, the electronic apparatus 1 transmits enumeration information thereof to the computer 2 such that the computer 2 acquires attributes and an operating manner of the electronic apparatus 1. Subsequently, the computer 2 assigns new address and end point so as to reach an agreement in the USB communication protocol, and then enters the status stage. Each of the above-mentioned stages is related to three packet types, that is, token, data and handshake. In the following steps of this embodiment, the handshake packet is processed, but it is not limited to the earlier setup stage or the later status stage.

In step S₃, the timer 14 of the electronic apparatus 1 starts countdown to a preset time limit when the USB communication protocol starts. Additionally, the computer 2 also starts countdown to an allowable connecting time limit when the USB communication protocol starts. The allowable connecting time limit associated with the computer 2 and the preset time limit associated with the electronic apparatus 1 will be described in detail in the following.

Step S₄ is to inspect operation of the USB communication protocol to determine whether a handshaking process between the electronic apparatus 1 and the computer 2 has been completed. In this step, the handshake packet in the setup stage, the data stage and the status stage is decoded for inspection. The handshaking process is determined to have been completed when a particular piece of information, such as an address, a transmission rate and a transmission volume, transmitted between the electronic apparatus 1 and the computer 2 has been confirmed. The above-mentioned particular piece of information is not limited to the disclosure of this embodiment, and can be any predetermined piece of information. Completion of the handshaking process means that the USB interface 11 of the electronic apparatus 1 is confirmatively connected to the USB interface 21 of the computer 2, which is similar to confirmation of the connection of the USB interface by detecting an identification pin in the conventional technique. Then, the flow goes to steps S₅ and S₆. When it is determined that the handshaking process has not been completed after a preset allowable handshaking time limit, such as in the case of disconnection of the USB interface 11, the flow goes back to step S₁.

Step S₅ is to notify the upper-level application program 16 for program termination, and to store data in the storage device 13.

In step S₆, while executing the operating system 15, the CPU 12 is operable to continuously determine whether storing of the data has been completed. Once storing of the data has been completed, that is, the storage device 13 can be dismounted safely, the flow goes to step S₇. When it is determined that storing of the data has not been completed, the flow goes to step S₈.

Step S₇ is to dismount the storage device 13 from the electronic apparatus 1, and to notify the computer 2 to mount the storage device 13.

Step S₈ is to determine whether the preset time limit, which the timer 14 started countdown in step S₃, has lapsed. The preset time limit is shorter than the allowable connecting time limit defined by the computer 2. When it is determined that the preset time limit has not lapsed, the flow goes back to step S₆ to once again determine whether storing of the data has been completed. When it is determined that the preset time limit has lapsed, that is, the allowable connecting time limit defined by the computer 2 is about to lapse, the flow goes to step S₉ to transmit a reset signal to the computer 2 for restarting the USB communication protocol between the electronic apparatus 1 and the computer 2 and for causing the computer 2 to restart countdown to the allowable connecting time limit. Therefore, the computer 2 will not determine the failure to mount the storage device 13 and thus stop connecting with the electronic apparatus 1 if mounting of the storage device 13 has not been completed within the allowable connecting time limit. In other words, the reset mechanism of step S₉ is used for extending the time for establishing the connection between the electronic apparatus 1 and the computer 2.

For instance, it assumed that the allowable connecting time limit defined by the computer 2 is 2 seconds and the preset time limit in this embodiment is 1.9 seconds. In the conventional technique, when the computer 2 has not completed mounting of the storage device 13 within 2 seconds, the computer 2 will determine the electronic apparatus 1 as an unidentifiable apparatus, determine failure in mounting, and stop connecting with the electronic apparatus 1. Steps S₆ to S₉ of this embodiment make the computer 2 restart countdown between 1.9 seconds and 2 seconds, to thereby extend the time for establishing the connection between the electronic apparatus 1 and the computer 2. Therefore, the upper-level application program 16 of the electronic apparatus 1 has enough time for program termination, and storing of data can be continued until it is completed. Then, the flow goes to step S₇ to safely dismount the storage device 13 to prevent data loss and damage to the storage device 13.

When dismounting of the storage device 13 from the electronic apparatus 1 and mounting of the storage device 13 to the computer 2 has been completed, the electronic apparatus 1 is configured to determine whether the USB interface 11 is disconnected in step S₁₀. The flow goes back to step S₁ when it is determined that the USB interface 11 is disconnected, and step S₁₀ is repeated when otherwise.

In conclusion, the method for dismounting a storage device of the present invention enables determination as to whether the electronic apparatus 1 is connected to the computer 2 by inspecting operation of the USB communication protocol therebetween. Therefore, the identification pin of the USB interface 11 can be used for other functions. Additionally, by virtue of the reset mechanism to extend the time for establishing the connection between the electronic apparatus 1 and the computer 2, it can be ensured that the storage device 13 is safely dismounted.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for dismounting a storage device to be implemented using an electronic apparatus that includes the storage device and a universal serial bus (USB) interface, said method comprising the steps of:
a) inspecting operation of a USB communication protocol between the electronic apparatus and a computer, that includes a USB interface and that is connected to the electronic apparatus via the USB interfaces, to determine whether a handshaking process between the electronic apparatus and the computer has been completed, and proceeding to step b) when it is determined that the handshaking process has been completed;
b) storing data in the storage device, determining whether storing of the data in the storage device has been completed, proceeding to step c) when it is determined that storing of the data in the storage device has been completed, and proceeding to step d) when it is determined that storing of the data in the storage device has not been completed after a preset time limit has lapsed, the preset time limit being shorter than an allowable connecting time limit defined by the computer;
c) dismounting the storage device from the electronic apparatus, and notifying the computer to mount the storage device; and
d) restarting the USB communication protocol between the electronic apparatus and the computer, and repeating step a).

2. The method for dismounting a storage device as claimed in claim 1, further comprising, before step a), the steps of:
i) performing detection to determine whether the USB interface of the electronic apparatus is connected to the USB interface of the computer; and
ii) when it is determined that the USB interface of the electronic apparatus is connected to the USB interface of the computer, starting the USB communication protocol between the electronic apparatus and the computer, and starting countdown to the preset time limit.

3. The method for dismounting a storage device as claimed in claim 2, wherein steps i) and ii) are repeated when it is determined in step a) that the handshaking process between the electronic apparatus and the computer has not been completed.

4. The method for dismounting a storage device as claimed in claim 1, wherein, in step d), the electronic apparatus is configured to transmit a reset signal to the computer for restarting the USE communication protocol between the electronic apparatus and the computer and for causing the computer to restart countdown to the allowable connecting time limit.

5. The method for dismounting a storage device as claimed in claim 1, wherein, in step a), the handshaking process is determined to have been completed when at least one particular piece of information transmitted between the electronic apparatus and the computer has been confirmed.

6. The method for dismounting a storage device as claimed in claim 5, wherein the particular piece of information includes one of an address, a transmission rate, and a transmission volume.

7. The method for dismounting a storage device as claimed in claim 1, wherein step b) includes notifying an upper-level application program for program termination.

8. A computer program product comprising a machine readable storage medium having program instructions stored therein which when executed cause an electronic apparatus having a storage device and a universal serial bus (USB) interface to perform a method for dismounting a storage device according to claim 1.

9. An electronic apparatus comprising:
a storage device storing a universal serial bus (USB) driver;
a timer configured to countdown a preset time limit;
a USB interface adapted to be connected to a USB interface of a computer; and
a central processing unit operable to execute the USB driver and to perform the steps of
inspecting operation of a USB communication protocol between the electronic apparatus and the computer to determine whether a handshaking process between the electronic apparatus and the computer has been completed, and
when it is determined that the handshaking process has been completed, storing data in said storage device, determining whether storing of the data in said storage device has been completed, dismounting said storage device from the electronic apparatus and notifying the computer to mount said storage device when it is determined that storing of the data in said storage device has been completed, and restarting the USB communication protocol between the electronic apparatus and the computer and repeating determination as to whether the handshaking process between the electronic apparatus and the computer has been completed when it is determined with reference to said timer that storing of the data in said storage device has not been completed after the preset time limit has lapsed.

10. The electronic apparatus as claimed in claim 9, wherein said central processing unit is configured to transmit a reset signal to the computer for restarting the USB communication protocol between the electronic apparatus and the computer and for causing the computer to restart countdown to an allowable connecting time limit when it is determined with reference to said timer that storing of the data in said storage device has not been completed after the preset time limit has lapsed.

11. The electronic apparatus as claimed in claim 10, wherein the preset time limit is shorter than the allowable connecting time limit that is defined by the computer.

12. The electronic apparatus as claimed in claim 9, wherein, while executing the USB driver, said central processing unit determines that the handshaking process has been completed when at least one particular piece of information transmitted between the electronic apparatus and the computer has been confirmed, the particular piece of information including one of an address, a transmission rate, and a transmission volume.

13. The electronic apparatus as claimed in claim 9, wherein said storage device further stores an application program and, while executing the USB driver, said central processing unit is configured to notify said application program for program termination when said central processing unit determines that the handshaking process between the electronic apparatus and the computer has been completed.
